(19) United States
(12) Patent Application Publication
(10) Pub. No.: US 2006/0276917 A1
(43) Pub. Date: Dec. 7, 2006

(54) Monitoring and control of electronic devices

(75) Inventors: Jinghong Li, San Jose, CA (US); Robert Lombaerde, Belmont, CA (US)

Correspondence Address: William L. Botjer, PO Box 478, Center Moriches, NY, 11934, US

(73) Assignee: BEAM EXPRESS, INC.

(21) Appl. No.: 11/144,413

(22) Filed: Jun. 3, 2005

(51) Int. Cl. G05B 15/00

(52) U.S. Cl. 700/83

(57) ABSTRACT

A method, a system, and a computer program product for managing one or more electronic devices. Performance of an electronic device is monitored and presented to a user through a Graphical User Interface (GUI) on a computer. The performance of the electronic device is controlled automatically, or by the user through the GUI. The invention also enables automatic testing of the electronic device through the GUI by setting up test configurations, activating test signals, and interpreting any error codes that may be generated. Further, data generated by the monitoring, control and testing of the electronic device can be saved.

### BACKGROUND

The invention relates generally to the field of electronics and communications. More specifically, the invention relates to the field of monitoring and control of electronic devices.

Electronic devices need to be monitored and controlled to ensure their optimal performance. Early detection of potential problems enables effective control to prevent failure of the electronic device.

One such electronic device is a communication device. Communication devices are electronic devices that function to transmit and/or receive data across communication links. The communication devices utilize different methods to transmit the data. For example, optical communication devices transmit information across fiber-optic media by using light signals from laser light sources. Optical communication devices enable high-speed data transmission that has become necessary due to the exponential increase in communication traffic around the world. The communication traffic, especially traffic related to the increasing use of the Internet, has placed a heavy demand on communication systems worldwide. Hence, efficient monitoring and control of communication devices is necessary to ensure continuous operation and reduced downtime.

Controlling an electronic device entails modifying certain parameters of the electronic device to optimize its performance. In an optical communication device, these parameters can include the DC voltage supplied to the laser light source and its on-off levels. The parameters can be controlled by one or more Integrated Circuits (ICs) that are present inside the device. For instance, the device can contain an IC that amplifies input signals. Further, the ICs contain certain specifically addressable memory locations or registers. The registers store values related to the performance of the electronic device. Modifying the values in certain registers modifies the performance of the electronic device. Thus, a user can control the performance of the electronic device through these registers.

Monitoring of an electronic device involves monitoring various parameters. For example, parameters such as fiber attenuation, optical power, and chromatic dispersion of a transmitted light signal can be monitored in an optical communication device. The monitoring can be performed through monitoring components external to the electronic device, or through internal monitoring components. For example, an external monitoring component can be a photocell monitoring the output power of the laser light source of an optical communication device. Alternatively, a voltmeter monitoring the input voltage supply can be contained inside the device. The internal monitoring components can store the monitored parameters in registers in the electronic device. The user can then monitor these parameters by reading these registers. Some registers can also be used to store information that is specific to the electronic device. This information can include specifications such as the serial number, the model, and the manufacturer of the device.

An electronic device generally requires opening of the device for monitoring and control. In some cases, to avoid accidents, the functioning of the electronic device needs to be interrupted before opening it. Further, opening the electronic device and using tools to monitor and/or control it can damage the electronic device. Additionally, manual control may not be optimal. Opening of the electronic devices is also time-consuming. Therefore, continuous control of the devices, based on functional and environmental monitoring, is difficult. It is also difficult to integrate control of the electronic device along with continuous monitoring by external monitoring components.

Hence, there exists a need for a method and a system that enables automated control of electronic devices without the need for opening them. The method and the system should integrate the monitoring and control of electronic devices, along with external test equipment. Further, the system should enable integrated control and testing of the electronic devices, continuously optimizing their performance, based on internal and external monitoring of the functional and environmental parameters.

### SUMMARY

The invention provides a method, a system, and a computer program product for monitoring and controlling one or more electronic devices.

An object of the invention is to manage one or more electronic devices, comprising monitoring the performance of at least one electronic device; presenting the monitored performance to a user through a Graphical User Interface (GUI); and controlling the monitoring, and the performance of the monitored electronic device, based on the monitored performance presented to the user.

Another object of the invention is to manage one or more electronic devices, comprising monitoring the performance of at least one electronic device; presenting the monitored performance through a GUI; controlling the monitoring, and the performance of the monitored electronic device, based on the monitored performance presented to the user; and enabling the user to control the performance of the monitored electronic device and the auxiliary electronic devices through the GUI.

Yet another object of the invention is to provide a system to manage one or more electronic devices, comprising one or more monitoring components, a monitoring component monitoring the performance of at least one of the plurality of electronic devices; a computer, the computer running a process for presenting the monitored performance to a user and for controlling the performance of the monitored electronic device and one or more auxiliary electronic devices; and at least one device interface, the device interface enabling communication between the plurality of electronic devices, the monitoring components and the computer.

A method and a system, in accordance with the invention, enable integrated monitoring and control of one or more electronic devices. An electronic device is monitored by monitoring components that can be external to or internal to the electronic device. The monitored performance is presented to a user through a GUI on a computer. The monitored performance can be presented to the user through a concise interface, as well as through a comprehensive interface that provides detailed information about the performance parameters. The system also enables automatic as well as manual control of the performance of the electronic device through the GUI. The system integrates monitoring and control of the electronic device along with the control of the monitoring components. The system further enables automatic testing of the electronic device through the GUI by setting up test configurations, activation of test signals, and interpretation of any error codes that may be generated. The system also enables saving of the data related to monitoring, control and testing of the electronic device.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates a system environment for managing an electronic device, in accordance with various embodiments of the invention;

FIG. 2 is a flow chart that illustrates a method to manage a plurality of electronic devices, in accordance with various embodiments of the invention; and

FIG. 3 is a screenshot illustrating a graphical user interface, in accordance with various embodiments of the invention.

### DETAILED DESCRIPTION OF THE PROFFERED EMBODIMENTS

Embodiments of the invention provide a method, system, and a computer program product for managing one or more electronic devices. The performance of the electronic devices is monitored and presented to a user through a graphical user interface. The interface further enables the user to control the electronic devices, either manually or automatically, based on the monitored performance. The embodiments of the invention will now be described in detail, with reference to the illustrations.

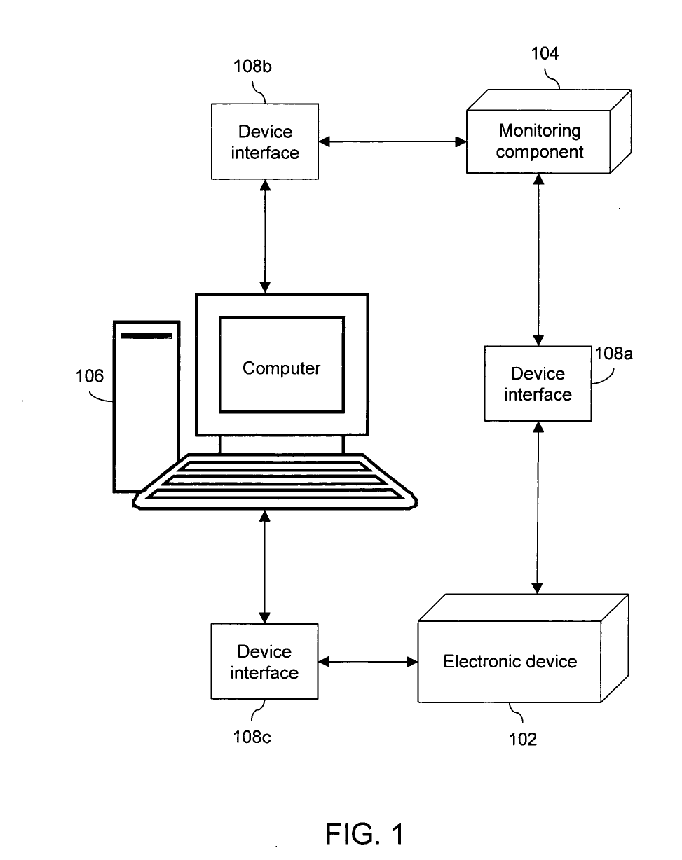

FIG. 1 illustrates a system environment for managing an electronic device, in accordance with various embodiments of the invention. The system environment includes an electronic device 102, a monitoring component 104, a computer 106, and device interfaces 108a, 108b, and 108c. Monitoring component 104 monitors the performance of electronic device 102, through device interface 108a. The monitored performance of electronic device 102 is communicated to computer 106 through device interface 108b. Computer 106 runs a process to present the monitored performance to a user. Computer 106 further enables manual control as well as automatic control to manage the performance of electronic device 102 through device interface 108c. The system elements of FIG. 1 are explained in detail hereafter.

Electronic Device 102

Electronic device 102 is a device performing its function through electronic means. In various embodiments, electronic device 102 is a communication device, such as an optical communication device, a copper wire transceiver, a radio transmitter, or any other electronic device that can be monitored and controlled. FIG. 1 illustrates only one electronic device 102. However, the number of electronic devices that can be supported by the various embodiments of the invention is not limited to one. The embodiments of the invention can enable simultaneous managing of two or more electronic devices.

Monitoring Component 104

Monitoring component 104 monitors the performance of electronic device 102. Monitoring component 104 is a device that is capable of monitoring the performance of electronic devices. Exemplary performance parameters being monitored include, but are not limited to temperature, wavelength, input signals, etc. For example, monitoring component 104 can be a spectrometer that monitors the wavelength of a light signal transmitted by an optical communication device. Another example of monitoring component 104 is a thermometer that monitors temperature of electronic device 102.

In one embodiment of the invention, monitoring component 104 is present inside electronic device 102. In this case, the monitored parameters can be stored in specific registers inside electronic device 102. Computer 106 reads these registers to acquire the information related to the monitored performance. In another embodiment, monitoring component 104 resides outside electronic device 102.

In an embodiment of the invention, monitoring component 104 is dedicated to monitor only one parameter related to electronic device 102. An example is a thermometer inside electronic device 102 that monitors only the environmental temperature. Alternatively, monitoring component 104 can monitor a plurality of parameters. For example, an oscilloscope can monitor both the input signals and the amplified signals inside electronic device 102.

In one embodiment, monitoring component 104 is a passive device that only monitors the performance of electronic device 102. For example, a thermometer monitors the temperature. In another embodiment, monitoring component 104 is an active device that monitors as well as modifies the performance of electronic device 102. For example, a test signal generator provides test signals for transmission to a communication device and then monitors the communication signal transmitted by the communication device.

In an embodiment of the invention, monitoring component 104 is dedicated to monitor only one electronic device. In another embodiment, monitoring component 104 monitors a plurality of electronic devices. Similarly, electronic device 102 can be monitored by a single monitoring component or by a plurality of monitoring components.

Computer 106

The monitored performance is presented to a user through a graphical user interface (GUI) on computer 106. Computer 106 is a computing device capable of presenting the monitored performance of electronic device 102 to a user. Computer 106 also enables control of electronic device 102, either automatically or manually by the user. In various embodiments, Computer 106 is dedicated to the system for managing a plurality of electronic devices. In other embodiments, computer 106 is a multiprocessing unit that runs other processes apart from managing electronic device 102. In an embodiment, the system comprises a plurality of computers for managing one or more electronic devices. The embodiments of the invention can be implemented in all types of computers such as, but not limited to, mainframes, desktops, servers, laptops, and notebooks.

Device Interfaces 108a, 108b, and 108c

Communication between computer 106, monitoring component 104, and electronic device 102 is enabled by device interfaces 108a, 108b, and 108c. In one embodiment, a plurality of monitoring components can be connected to computer 106 through one device interface. Similarly, a plurality of electronic devices can be connected to computer 106 through one device interface. In an alternate embodiment, the electronic devices as well as monitoring components can be connected to computer 106 through the same device interface. Alternatively, each monitoring component and electronic device may use a distinct device interface for communication with computer 106.

In an embodiment of the invention, device interface 108c between computer 106 and electronic device 102 is a Management Data Input Output (MDIO) communication interface. Electronic device 102 can contain internal ICs that communicate with the MDIO through an Inter-IC (12C) bus. In various embodiments, device interface 108c is a general purpose input/output (GPIO) interface. Similarly, in some embodiments, device interface 108b between monitoring component 104 and computer 106 can also be an MDIO interface or a GPIO interface. Further, in various embodiments of the invention, device interfaces between different electronic devices and computer 106, and between different monitoring components and computer 106 can follow different communication standards. The device interfaces enable two way communication with the electronic device to pass the monitored signals to the computer as well as to pass commands from the computer to the electronic device.

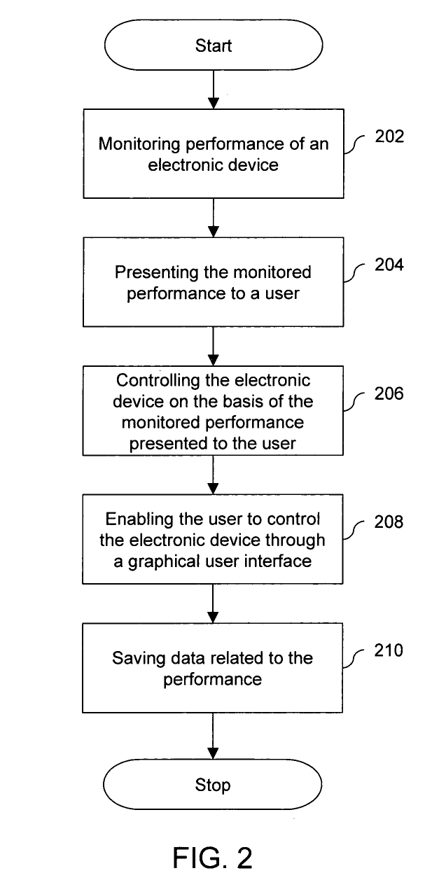

In accordance with various embodiments, the invention provides a method for managing a plurality of electronic devices. The flowchart for the method is illustrated in FIG. 2. At step 202, the performance of electronic device 102 is monitored by monitoring component 104. At step 204, the monitored performance is presented to the user through computer 106. At step 206, the performance of electronic device 102 is controlled, based on the monitored performance presented to the user. At step 208, the user is enabled to control electronic device 102 through a GUI presented on computer 106. At step 210, the data related to the performance of electronic device 102 is saved. Some of the method steps and their various embodiments are hereinafter described in detail.

Monitoring the performance of the electronic device, i.e., step 202 Monitoring of electronic device 102 by the monitoring component 104 involves monitoring of various parameters related to electronic device 102. The parameters can be related to the environment of electronic device 102, such as temperature, humidity, and voltage supply. The parameters can also be related to the specifications of electronic device 102, such as the manufacturer's name, model number, and device serial number. Further, the parameters can be related to the functions performed by electronic device 102. For example, in one embodiment, electronic device 102 is an optical communication device. In this case, the monitored parameters include optical power of light source, fiber attenuation, chromatic dispersion, alignment of fibers, polarization of light, bias current, extinction ratio, voltage supply to light source, input signal level, transmitted signal level, and received signal level. The list of parameters is illustrative only. It will be apparent to a person skilled in the art that the monitored parameters will vary with the specific electronic device monitored. Hence, the different parameters that can be monitored by the method and system of the present invention are not limited by the list provided.

In one embodiment, monitoring component 104 communicates the monitored performance of electronic device 102, to computer 106, continuously through device interface 108b. Continuous monitoring of electronic device 102 provides a real-time status of the performance. In another embodiment, the monitored performance is communicated to computer 106 at regular time intervals. Alternatively, the monitored parameters are communicated to computer 106 by exception, when the monitored performance falls outside a desired range. The desired range can vary with the monitored parameter and the specific electronic device. For example, the input voltage range for one electronic device can be 105V-115v, while for another electronic device the input voltage range can be 220V-240V.

Presenting the Monitored Performance to a User, i.e. Step 204

In an embodiment of the invention, the performance of electronic device 102, monitored by monitoring component 104, is presented to a user through a GUI on computer 106.

In one embodiment of the invention, the monitored performance is presented to the user through a concise interface. The concise interface presents information suitable for a daily operator of the system. The daily operator is a user who operates electronic device 102 on a daily basis, and who does not need to delve into the detailed performance of electronic device 102. The performance status of electronic device 102 can be presented using different colors. The interface can also provide alarms to alert the operator when the monitored performance is outside the desired range. Further, the interface can prompt the operator for corrective actions that are required to be taken, in response to the alerts. In addition, the operator can be provided a description about any error codes that may be generated during the monitoring. In an embodiment of the invention, where electronic device 102 is a communication device, the interface can present the activity status of the device, data transfer rate, and usage information about the device. The interface can incorporate alarms when the voltage supplied to the communication device falls below the desired range, and prompt the operator to check the power supply.

In another embodiment, the monitored performance is presented to the user through a comprehensive interface. The comprehensive interface presents detailed information that is suitable for a technical specialist in the field of electronic device 102. Herein, the technical specialist is a user who is interested in the detailed performance of electronic device 102. The interface presents individual values of the monitored parameters. The interface can also present readout of individual registers of electronic device 102. Further, information related to troubleshooting of the performance can be provided to the user. In an embodiment of the invention, where electronic device 102 is an optical communication device, the bit rate of the communication connection, the input signal level, signal modulation frequency, wavelength of light transmitted, and current levels to the laser light source can be some of the values that are presented to the user.

Controlling the Performance of the Electronic Device, i.e., Step 206

Controlling of the performance of electronic device 102 involves modifying the various parameters of electronic device 102, in order to optimize its performance. The parameters modified are specific to the electronic device and are related to its function. For example, in an optical communication device, the parameters that can be modified include bias current, extinction ratio, voltage supply to light source, and transmission power. This list is not comprehensive and it will be apparent to a person skilled in the art that there exist numerous other parameters that can be modified to control the performance of an optical communication device in particular and an electronic device in general.

In one embodiment of the invention, electronic device 102 contains ICs. The embodiments of the invention enable controlling the ICs inside electronic device 102 to control the performance of electronic device 102. In one embodiment, the ICs are programmed to enable individual monitoring and control of the ICs contained inside electronic device 102. For instance, where electronic device 102 is an optical communication device, the device can control individual ICs for amplifying input signal level, changing the extinction ratio, changing bias current to the LED light source. In various embodiments, the invention enables individual control of all the ICs, hence enabling individual control of the different functions performed by the ICs.

In an embodiment, the invention enables automatic control of the performance of electronic device 102 based on its monitored performance. The performance of electronic device 102 is modified automatically to optimize it, based on the changes observed during monitoring. For example, an embodiment of the invention can enable controlling of electronic device 102 to compensate for any change in the temperature of the environment. Hence, the performance of electronic device 102 is automatically optimized for the environmental temperature.

In another embodiment, the invention enables a user to control the performance of electronic device 102, through a GUI. The user controls the performance of electronic device 102, based on the monitored performance presented to him through the GUI.

In one embodiment of the invention, the GUI provides a concise interface for the user to control the performance of electronic device 102. The daily operator can use this interface to control the routine parameters related to the performance of electronic device 102. In an embodiment, where electronic device 102 is a communication device, operator control can be enabled for parameters such as protocol used and speed for the data transfer.

In another embodiment, the GUI provides a comprehensive interface for the user. The comprehensive interface enables the technical specialist to individually control specialized parameters, and specific ICs inside electronic device 102. The interface enables the user to modify the values of individual registers inside electronic device 102. In an embodiment, the invention enables a user to enter company- and device-specific information in the registers such as the serial number of the device, manufacturer name and model specifications. In an embodiment, where electronic device 102 is an optical communication device, the comprehensive interface enables the user to control various parameters such as laser optical levels, signal modulation, and bias current settings.

In various embodiments of the invention, controlling of electronic device 102 is incorporated with the monitoring to enable its integrated testing. The testing can also be integrated with the performance monitored by monitoring components that are external to electronic device 102. Further, an embodiment of the invention enables control of monitoring component 104 along with simultaneous monitoring and control of electronic device 102. Additionally, the embodiment of the invention also enables looping of test signals, through electronic device 102, back to monitoring component 104. Hence, the embodiments of the invention enable comprehensive tests on electronic device 102, controlling the various device parameters, while simultaneously monitoring the performance of electronic device 102, through internal and external monitoring components. This enables determining the level of performance of electronic device 102. Further, any errors in the performance and reasons for these errors can be determined.

In an embodiment of the invention, the user performs various tests on electronic device 102, by selecting the test through the GUI. In various embodiments, the invention automatically sets up test configurations for electronic device 102 and monitoring component 104, based on the test selected by the user. The results of the tests can be presented in a concise interface such as through pass or fail indications. Alternatively, the results can be presented in a comprehensive manner, such as detailed register listings.

In an embodiment, where electronic device 102 is an optical communication device, the invention enables loop-back of both optical signals as well as electrical signals. Monitoring component 104 generates test data for transmission by the optical communication device. The light signals that are transmitted by the optical communication device are looped back to monitoring component 104. This enables testing efficiency of data transmission by the optical communication device. Further, monitoring component 104 can generate test signals for modifying the various parameters and registers of the optical communication device. The changes in the performance of the optical communication device, and the internal register values are looped back to monitoring component 104. This enables comprehensive testing to correlate the errors in the performance along with the internal causes of the errors. The embodiments of the invention enable automated testing by setting up suitable configurations for the optical communication device and monitoring component 104. The embodiments of the invention enable automatically attenuating routine communications through the optical communication device, turning on generation of the test signals, and looping back signals from the optical communication device to monitoring component 104.

Saving Data Related to the Performance, i.e., Step 208

In one embodiment of the invention, the data related to monitoring, controlling, and testing of the performance of electronic device 102, is saved by computer 106. This data can be used for future analysis and optimization of the performance of electronic device 102. In various embodiments, the invention enables automatic saving of the data related to monitoring and control, in a Microsoft Excel file format or any other suitable format.

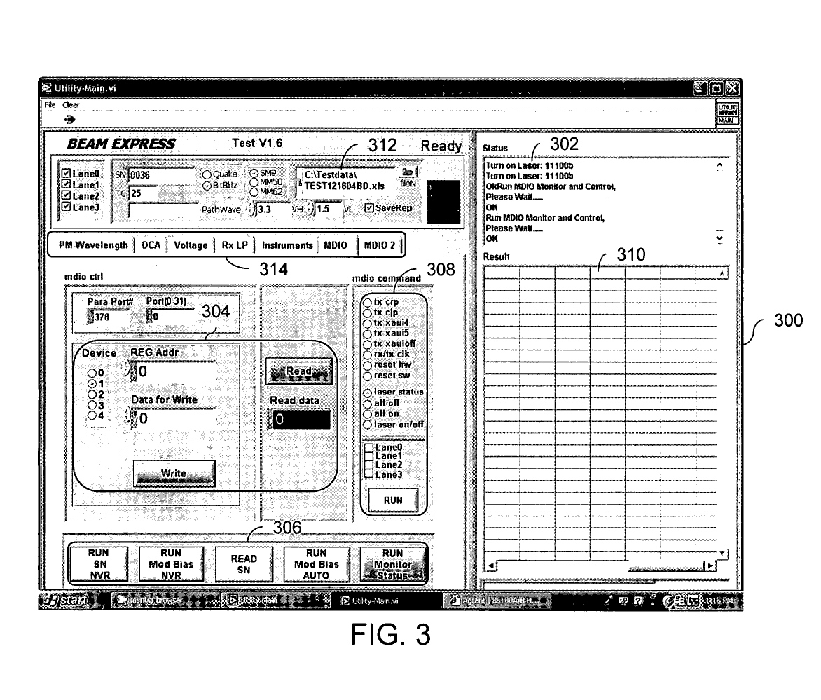

FIG. 3 illustrates a GUI 300, in accordance with various embodiments of the invention. GUI 300 provides a comprehensive interface for the user to monitor, control, and save the performance related data for electronic device 102. GUI 300 is depicted only for illustration purposes. The specific interface can vary in different embodiments of the invention. In this case, electronic device 102 is an optical communication device. The monitoring and control of the optical communication device is performed through MDIO. GUI 300 presents the monitored performance of the optical communication device in a concise format through an interface 302. An interface 304 enables a user to read and write data in individual registers in the optical communication device.

GUI 300 also provides a set of buttons 306. Buttons 306 enable the user to run specific tests and commands on the optical communication device. According to an embodiment of the invention, buttons 306 can comprise a ‘Run SN NVR’ button. The ‘Run SN NVR’ button enables the user to enter the serial number in the registers of the optical communication device. Another button, ‘Run Mod Bias NVR’ enables the user to manually control the amplitude and drive level of the laser in the optical communication device. Buttons 306 also comprise a ‘Read SN’ button. According to an embodiment of the invention, the ‘Read SN’ button reads the serial number entered in the optical communication device. Buttons 306 also comprise a ‘Run Mod Bias Auto’ button that enables automatic control of the amplitude and drive level of the laser. Buttons 306 also comprise a ‘Run Monitor Status’ button, which displays the status of the optical communication device through colored indicators.

The user can run further device-specific and detailed commands on the optical communication device through an interface 308. The results of the tests and the commands run by the user are presented in a detailed listing through an interface 310. The data related to the monitoring, control, and testing is saved through an interface 312.

A set of tabs 314 further enables the user to monitor, control, and test other parameters of the optical communication device and external monitoring components that are managed by GUI 300. According to the embodiment, tabs 314 include ‘PM-Wavelength’, ‘DCA’, ‘Voltage’, ‘Rx LP’, ‘Instruments’, ‘MDIO’, ‘MDIO 2’, The ‘PM-Wavelength’ tab enables the optical communication device to transmit signals and loops the optical signals to a wavelength meter. The wavelength meter is then controlled to read the optical wavelengths and display the results on GUI 300. The ‘DCA’ tab loops the optical signal to a digital signal analyzer (DCA). The DCA can then be controlled through GUI 300 to monitor specific parameters of the optical communication device. In this case, the user does not need to manually press the switches on the DCA. The ‘Voltage’ tab enables the user to select the power supply and control the voltage of the power supply for the optical communication device. The ‘Rx LP’ tab enables loop back testing of the optical communication device by activating an internal data pattern and measuring received errors, while simultaneously increasing optical attenuation. The ‘Instruments’ tab enables individual control of the instruments through a GPIO interface. The ‘MDIO’ tab enables control of registers to display and control the status of the optical communication device through colored indicators. The ‘MDIO 2’ tab displays the temperature and resistive settings of the laser light sources.

The interfaces, buttons, and tabs illustrated in FIG. 3 should not be construed to limit the scope of the invention. The actual interface can vary in different embodiments of the invention.

It will be evident to a person ordinarily skilled in the art that one or more of the embodiments mentioned above provide the following advantages for managing a plurality of electronic devices. The embodiments of the invention enable integrated monitoring and control of electronic devices through a user-friendly interface. The embodiments of the invention also enable continuous monitoring of the performance of the electronic devices. A real-time status of the performance of the electronic devices is presented to a user, and the embodiments of the invention enable the user to control the electronic devices based on the monitored performance. Furthermore, the embodiments of the invention enable automatic control of the electronic devices to optimize the performance based on the monitored parameters. The embodiments of the invention also enable integrated monitoring and control of the electronic devices along with external monitoring components to present a comprehensive status of the performance of the electronic devices. In addition, the embodiments of the invention enable automated testing of the electronic devices, and eliminate the need for opening of the electronic devices for tests.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. A computer comprises a microprocessor. This microprocessor is connected to a communication bus. The computer also includes a memory. This memory may include Random Access Memory (RAM) and Read Only Memory (ROM). A computer system further comprises a storage device. It can be a hard disk drive or a removable storage drive such as a floppy disk drive, optical disk drive and so forth. A storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine. The processing of input data by the processing machine may be in response to user commands, or in response to results of previous processing or in response to a request made by another processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The instructions can also be implemented using only software programming or using only hardware or by a varying combination of the two techniques. The instructions are independent of the programming language used and the operating system in the computers. The instructions for the invention can be written in all programming languages including, but not limited to ‘C’, ‘C++’, ‘Visual C++’ and ‘Visual Basic’. The instructions can be implemented in all operating systems and platforms including, but not limited to ‘Unix’, ‘DOS’, and ‘Linux’.

The instructions for implementing the method and the system can be stored and transmitted on a computer readable medium. The set of instructions can also be transmitted by data signals across a carrier wave. Further, the invention can be embodied in a computer program product comprising the computer readable medium, the product capable of implementing the above methods and systems, or the numerous possible variations thereof.

While a few embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A system to manage one or more electronic devices, the system comprising:
a. one or more monitoring components, a monitoring component monitoring the performance of at least one of the plurality of electronic devices;
b. a computer, the computer running a process for presenting the monitored performance to a user and for controlling the performance of the monitored electronic device and one or more auxiliary electronic devices; and
c. at least one device interface, the device interface enabling communication between the plurality of electronic devices, the monitoring components and the computer.

2. The system according to claim 1, wherein the monitored electronic device is a communication device.

3. The system according to claim 1, wherein the monitored electronic device is an optical communication device.

4. The system according to claim 1, wherein the monitored electronic device contains integrated circuits, wherein at least one of the integrated circuits being monitored and controlled.

5. The system according to claim 1, wherein at least one monitoring component is internal to the monitored electronic device.

6. The system according to claim 1, wherein the computer enables control of the monitored electronic device and auxiliary electronic devices by the user, through a graphical user interface.

7. The system according to claim 1, wherein the device interface being a management data input-output (MDIO) interface.

8. A method for managing one or more electronic devices, the method comprising the steps of:
a. monitoring the performance of at least one electronic device;
b. presenting the monitored performance to a user through a Graphical User Interface (GUI); and
c. controlling the monitoring, and the performance of the monitored electronic device, based on the monitored performance presented to the user.

9. The method according to claim 8, wherein the step of monitoring comprises monitoring the performance of at least one communication device.

10. The method according to claim 8, wherein the step of monitoring comprises monitoring the performance of at least one optical communication device.

11. The method according to claim 8, wherein the step of monitoring comprises monitoring one or more parameters selected from a group of parameters consisting of temperature, humidity, input signal level, external voltage supply, manufacturer name, model specification, optical power of light source, fiber attenuation, chromatic dispersion, alignment of fibers, polarization of light, power of received signal, bias current, extinction ratio, voltage supply to light source, and transmission power.

12. The method according to claim 8, wherein the step of monitoring comprises the monitoring being performed through a component internal to the monitored electronic device.

13. The method according to claim 8, wherein the step of controlling comprises controlling through the GUI.

14. The method according to claim 8, wherein the step of controlling comprises modifying one or more parameters selected from a group of parameters consisting of bias current, extinction ratio, voltage supply to light source, and transmission power.

15. The method according to claim 8, wherein the steps of monitoring and controlling further comprise testing the monitored electronic device.

16. The method according to claim 8, wherein the steps of monitoring and controlling are performed through a management data input output (MDIO) interface.

17. The method according to claim 8, further comprising the step of saving data related to the performance.

18. A method for managing one or more electronic devices, the method comprising the steps of:
a. monitoring the performance of at least one electronic device;
b. presenting the monitored performance through a graphical user interface;
c. controlling the monitoring, and the performance of the monitored electronic device, based on the monitored performance presented to the user; and
d. enabling the user to control the performance of the monitored electronic device and auxiliary electronic devices through the graphical user interface.

19. A computer program product for use with a computer, for managing one or more electronic devices, the computer program product performing the steps of:
a. monitoring the performance of at least one electronic device;
b. presenting the monitored performance through a graphical user interface; and
c. controlling the monitoring, and the performance of the monitored electronic device, based on the monitored performance presented to the user.

20. A computer program product for use with a computer, for managing one or more electronic devices, the computer program product performing the steps of:
a. monitoring the performance of at least one electronic device;
b. presenting the monitored performance through a graphical user interface;
c. controlling the monitoring, and the performance of the monitored electronic device, based on the monitored performance presented to the user; and
d. enabling the user to control the performance of the monitored electronic device and auxiliary electronic devices through the graphical user interface.
